(19) United States
(12) Patent Application Publication
(10) Pub. No.: US 2008/0295914 A1
(43) Pub. Date: Dec. 4, 2008

(54) ANTI-SPLATTER PAD FOR DRAIN PAN

(75) Inventor: Edwardo Avalos, Chandler, AZ (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/834,763

(22) Filed: Aug. 7, 2007

Related U.S. Application Data
(63) Continuation-in-part of application No. 11/755,792, filed on May 31, 2007.

(51) Int. Cl. B67C 3/00

(52) U.S. Cl. 141/7; 141/110

(57) ABSTRACT

A drain pan for oil and other automotive fluids comprises a collection pan having a liner pad consisting essentially of a layer of non-woven synthetic polyester fiber bonded sin binders.

### CROSS REFERENCE TO RELATED APPLICATION

This application is a continuation-in-part application of Ser. No. 11/755,792 filed May 31, 2007 entitled Anti-Splatter Pan for Drain Pan for which priority is claimed.

### BACKGROUND OF THE INVENTION

In a principal aspect the present invention relates to an anti-splatter pad for a drain pan of the type for collecting fluids such as oil draining from a vehicle. The pad is used to preclude or diminish splattering of fluid as it is drained into a drain pan.

When servicing automobiles, trucks and other vehicles, a technician will often drain the oil from the engine, drain brake fluid, drain radiator fluid, or drain other fluids from the vehicle. A typical device used to collect the fluid from the vehicle comprises a funnel which receives the stream of draining fluid and directs the fluid through a tube and into a receptacle or container for subsequent recycling or destruction. U.S. Pat. No. 6,367,586 discloses a typical fluid collection funnel construction of this nature and is incorporated by reference.

A problem often observed with fluid collection devices, however, is splattering of the fluid as it exits, for example, from an oil pan for an engine block or from some other reservoir of an engine or vehicle into a collection funnel. The splattering fluid may be a pollutant or, if uncontrolled, may cause a hazard. Thus, there has developed a need for some means to eliminate the splattering or splashing associated with the collection of fluids in a funnel or pan.

It has been suggested to use a lining for the collector, such as for a collector funnel, to obviate the splattering problem. Numerous materials have been suggested or tested in an effort to identify an appropriate material that avoids or eliminates splattering and splashing of the fluid as it is drained from a vehicle engine. For example, closed cell foams, sponges, sponges wrapped with cloth material, various cloths, paper products, and metal screens have all been suggested and tested. None of these solutions have proven successful. Another approach has been the adoption of shaped or configured protrusions in the surface of the collection pan. This, too, has been unsuccessful. One feature of the experimentation has been the observation that lower viscosity fluids have a higher propensity to cause splattering. Nonetheless, almost all fluids associated with vehicle servicing have the problem of the splattering of fluids during draining from the engine or other part of a vehicle. Thus, the problem of resolving the issue of splattering of fluid material has persisted. It is with this background that further experimentation and development was undertaken in order to devise a system which would substantially eliminate the splatter associated with the draining of such fluid materials over a wide range of viscosities particularly during the collection of the fluids in a funnel or other style of collection pan.

### SUMMARY OF THE INVENTION

Briefly, the present invention comprises a drain pan liner pad useful for lining a collection funnel or pan to prevent fluid splattering. Typically, a funnel may have a frustoconical shape with a cylindrical top wall and a center, coaxial opening which connects to a tube that leads to a collection container. Importantly, the liner pad is positioned over the interior of the drain funnel or pan. The pad has a configuration or shape which generally covers the interior of the pan and may be congruent or otherwise compatible with the configuration or shape of the pan. The pad consists essentially of a non-woven synthetic polyester fiber bonded with resin binders. The fibers have a nominal diameter in the range of 0.007±0.001 inches with irregularly spaced globules on the fibers having a diameter of about 0.010-0.030 inches. The density of the pad per unit volume of the pad at room temperature in the range of 0.180 to 0.210 gr/cc. The density of the pad fibers including the surface globules is about 7.0 to 7.8 gr/cc. The pad has a generally uniform thickness of typically at least about ½ inch. The pad may include a central opening which is congruent with an opening from the drain pan to a collection container. However, the central opening in the liner pad is not necessary or necessarily preferred. The choice of the pad material including its configuration, thickness, construction and arrangement, however, are considered to be critical features of the invention.

Thus, it is an object of the invention to provide an improved drain pan pad construction for use with a collection pan for fluids from an automotive vehicle.

It is a further object of the invention to provide an inexpensive, yet highly efficient drain pad construction which will preclude the splattering of collected fluids having a wide range of viscosities.

Yet another object of the invention is to provide a fluid collection device which is inexpensive, rugged and which is easy to service.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view illustrating a typical fluid collection device wherein it is positioned to collect fluid being drained from a vehicle; namely, oil from the oil pan of a vehicle engine wherein the drain plug of the vehicle oil pan has been removed or opened and the device incorporates a liner pad in accord with the invention;

FIG. 2 is a top plan view of the liner pad and a pan associated with the collection device of FIG. 1;

FIG. 3 is a cross sectional view of the collection device of FIG. 2 taken along the line 3-3;

FIG. 4 is an enlarged portion of a section of the padding material or pad which is utilized in combination with a collection pan to insure that fluid draining into the pan will not splatter;

FIG. 5 is an enlarged view of a portion of a single fiber of the mesh or pad of FIG. 4; and

FIG. 6 is a cross sectional view of a liner pad and funnel construction of an embodiment of the invention.

### DESCRIPTION OF AN EMBODIMENT OF THE INVENTION

Referring to the figures, a typical fluid drain pan and fluid collection device includes a drain pan or collector 20 which is designed to receive a flow of fluid such as oil 22 from a drain pan 24 of a motor vehicle wherein a drain plug 26 has been removed therefrom to permit the flow. The drain pan 20 typically includes a generally cylindrical upper wall 28 joined to a frustoconical section or frustoconical collection funnel 30 having a central opening 32 connected to a discharge tube 34 that directs fluid into a collection container 36. The collection pan 20 typically will have a center line axis 38 which is coincident with the axis of the frustoconical pan 30 and the cylindrical wall 28 as well as the tube 34.

Positioned on the interior wall or fluid incident surface 31 of the frustoconical section 20 is a pad 40. That is, the interior wall of the frustoconical pan 20 is generally a smooth surface wall inasmuch as the pan 20 may be made from a molded plastic material, for example, or from sheet metal, or the like. The pad 40 is positioned on the inside or interior of frustoconical section 30. The pad 40 has a generally congruent shape with respect to the frustoconical section 30 and may include a central opening or passage 42 through which oil or fluid drains into a central collection tube 34 of the funnel or pan and downwardly into the collection container 36.

The pad 40 thus generally fits over the funnel 30 but need not fit against the surface thereof. It preferably fits loosely for easy removal or replacement. Also, the pad 40 preferably does not include a central opening aligned with the tube 34 and is above the surface 31 of the pan or funnel as depicted in cross section in FIG. 6. The pad 40 consists essentially of a layer of non-woven synthetic polyester fiber bonded with resin binders. The fibers, such as the fibers 43 in FIG. 4, have a nominal diameter of 0.007±0.001 inches. The fibers are non-woven, but form a mesh wherein the volume of the solids of the mesh per unit volume of the pad material comprise a density in the range of 0.180 to 0.210 grams per cubic centimeter. The fiber materials typically have a solid weight per cubic centimeter of 7.0 to 7.8 grams. Because the fibers 43 are non-woven but form a mesh of fibers 43 spaced one from the other and a significant portion of the mesh will not be occupied by a solid fiber material. Consequently, the fibers 43 which form the solid portion of the mesh will form and provide for a density of material per unit volume at room temperature in the range of 0.180 to 0.210 grams per cubic centimeter.

The pad 40 will generally have a uniform thickness, although the thickness may be varied from portion to portion. The uniform thickness measured by the dimension of 46 in FIG. 4 is typically greater than ⅛ inch and at least about ½ inch. The thickness of the liner pad 40 is typically one inch for a pan or funned of six inches or greater diameter. The pad 40 may be congruent in shape and configuration with the interior surface of the frustoconical section 30. Importantly, the fibers 43 include irregularly spaced surface globules 45 or protrusions (FIG. 5) which have a diameter of about 0.010±0.002 inches, but may have a diameter up to 0.030 to 0.002 inches. The globules 45 are randomly spaced to diffuse the fluid flow randomly as it flows through the mesh and thereby precludes splatter over a large range of fluid viscosity. The number of globules 45 per linear centimeter of fibers 43 is in the range of about 2 to 6.

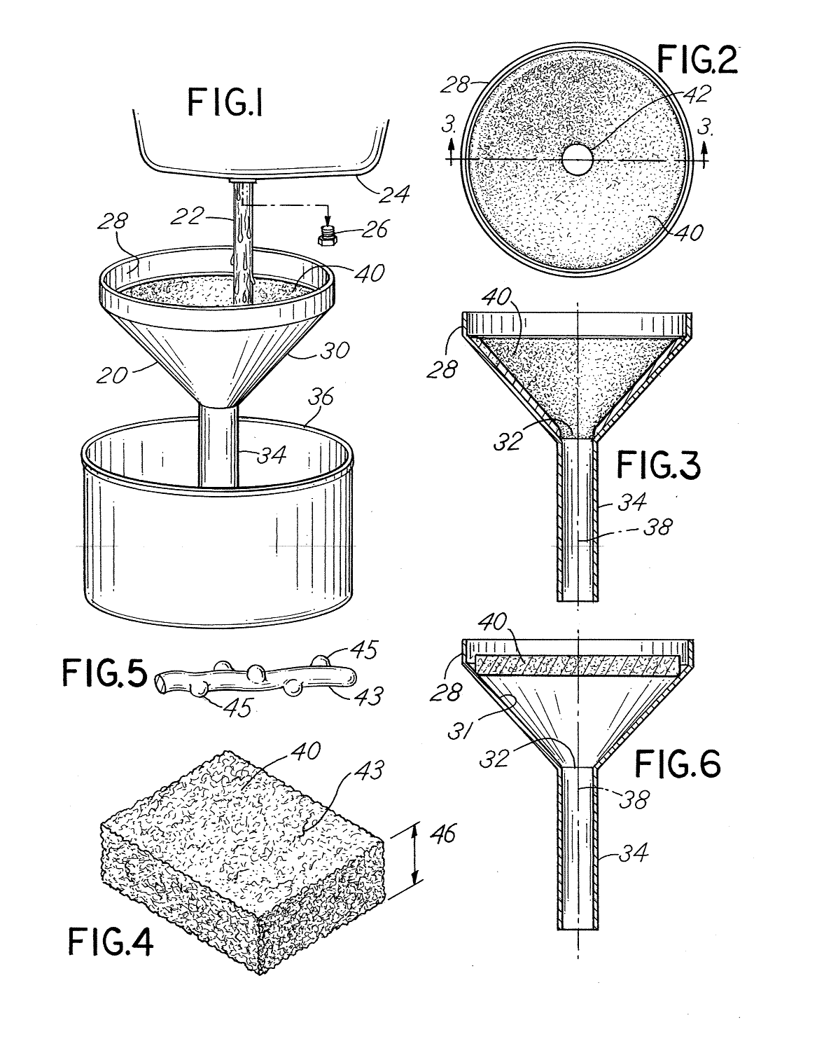

When used, the padded drain pan construction is positioned with the funnel section thereof beneath the drain plug as depicted in FIG. 1. The drain plug 26 is then removed and fluid is drained into the funnel by directing the fluid onto the pad 40. The configuration in the material of the pad 40 has been found to preclude splashing of the draining fluid with respect to the fluids associated with motor vehicles which include brake fluid, engine oil, transmission fluid and radiator fluid. This is to be contrasted with the utilization of other padding type materials which were tested in an effort to determine whether they would effectively eliminate splattering. Those other materials included closed cell foams, sponges, various other types of mesh materials, sponges wrapped with cloth, various types of cloth, various types of paper, metal screen and the forming of various configurations and protrusions in the base of the pan or frustoconical section 30.

A typical mesh which is found to be utilitarian in the practice of the invention is a non-woven material which is advertised as an abrasive floor pad material available from Glit-Microtron Company identified as thick black strip non-woven fiber material offered by Glit-Microtron, 809 Broad Street, Wrens, Ga., 30833. The material is defined as having an inorganic content of 35±15% with a tensile strength (md) of 50 pounds per square inch.

While there has been disclosed an embodiment of the invention, it is to be understood that the invention is limited only by the following claims and equivalents thereof. Thus, variations of features of the invention may be undertaken without departing from the spirit and scope of the invention. For example, the shape and configuration and arrangement of the collection pan may be varied. The thickness of the non-woven padding may be varied. However, as a result of the testing conducted, it has been discovered that it is essential to use padding of the type described inasmuch as other padding materials and other liners and configurations of collection funnels do not solve the problem associated with prevention of splattering.

What is claimed is:

1. A drain pan and padding for oil and automotive fluids comprising in combination:
a liner pad for placement over or above the surface of a fluid collection pan consisting essentially of a layer of non-woven, synthetic polyester fiber bonded with resin binders, said fibers having a nominal diameter of 0.007±0.001 inches and a density of solids per unit volume at room temperature in the range of about 0.180 to 0.210 grams per cubic centimeter, said pad having a generally uniform thickness of at least about ½ inch, a solid fiber density of about 7.0 to 7.8 grams per cubic centimeter, and irregularly spaced surface globules on said fibers having a diameter of about 0.010±0.002 to 0.030±0.002 inches and in the range of about 2 to 6 globules per linear centimeter of fiber.

2. A method for draining oil or other automotive fluid from a motor vehicle comprising the steps of
(a) positioning a drain pan including a pad liner aligned generally beneath a drain; and
(b) draining the fluid into the pan by directing the fluid onto the pad to preclude splashing of the draining fluid.

3. The method of claim 2 wherein said fluid is a liquid selected from the group consisting of oil, brake fluid, radiator fluid, transmission fluid and combinations thereof.
